(19) United States
(12) Patent Application Publication
(10) Pub. No.: US 2026/0299457 A1
(43) Pub. Date: Oct. 1, 2026

(54) CHARGING DEVICE AND IMAGE FORMING APPARATUS

(71) Applicant: FUJIFILM Business Innovation Corp., Tokyo (JP)

(72) Inventors: Yudai KAMATANI, Kanagawa (JP); Masaya FUKUSHIMA, Kanagawa (JP); Yuki NAGAMORI, Kanagawa (JP); Go MIURA, Kanagawa (JP); Taro MITSUI, Kanagawa (JP); Ibuki MASUDA, Kanagawa (JP)

(73) Assignee: FUJIFILM Business Innovation Corp., Tokyo (JP)

(21) Appl. No.: 19/256,075

(22) Filed: Jun. 30, 2025

(30) Foreign Application Priority Data
Mar. 26, 2025 (JP) 2025-052125

(51) Int. Cl. G03G 15/02

(52) U.S. Cl. CPC G03G 15/0291

(57) ABSTRACT

A charging device includes a discharge electrode, and a control electrode that is disposed between the discharge electrode and a member to be charged, in which an interval between the control electrode and the member to be charged at a downstream portion of the control electrode in a rotation direction of the member to be charged is larger than that at an upstream portion of the control electrode.

### CROSS-REFERENCE TO RELATED APPLICATIONS

This application is based on and claims priority under 35 USC 119 from Japanese Patent Application No. 2025-052125 filed Mar. 26, 2025.

### BACKGROUND

### (i) Technical Field

The present invention relates to a charging device and an image forming apparatus.

### (ii) Related Art

A technique disclosed in JP2012-220724A (Paragraph 0026 to 0037 and FIGS. 3 and 5) to be described below is publicly known in the related art in regard to a charger that charges the surface of an image holder in an electrophotographic image forming apparatus in the related art.

JP2012-220724A (Paragraph 0026 to 0037 and FIGS. 3 and 5) discloses a configuration in which a grid electrode (23) of a charging device (14) is curved. JP2012-220724A (Paragraph 0026 to 0037 and FIGS. 3 and 5) discloses a configuration in which an interval between the grid electrode (23) and a photoreceptor drum (13) is larger on an upstream side than on the downstream side in the rotation direction of the photoreceptor drum (13).

### SUMMARY

Aspects of non-limiting embodiments of the present disclosure relate to a charging device and an image forming apparatus that suppress charging unevenness in a longitudinal direction of a control electrode as compared to a case where the control electrode is curved in a lateral direction to correspond to the curvature of a member to be charged.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

In order to achieve the technical object, according to an aspect of the present disclosure, there is provided a charging device including a discharge electrode and a control electrode that is disposed between the discharge electrode and a member to be charged, in which an interval between the control electrode and the member to be charged at a downstream portion of the control electrode in a rotation direction of the member to be charged is larger than an interval between the control electrode and the member to be charged at an upstream portion of the control electrode.

### BRIEF DESCRIPTION OF THE DRAWINGS

Exemplary embodiment(s) of the present invention will be described in detail based on the following figures, wherein:

FIG. 1 is an overall view of an image forming apparatus of Example 1 of the present invention;

FIG. 2 is a diagram illustrating a visible image forming device that includes an image holder unit and a developing unit;

FIG. 3 is a perspective view of a charger of Example 1 of the present invention;

FIG. 4 is a cross-sectional view of a major part of the charger of Example 1 of the present invention;

FIG. 5 is an enlarged view of a major part of a charging device of Example 1;

FIGS. 6A, 6B, and 6C are diagrams illustrating configurations of Experimental Examples, FIG. 6A is a diagram illustrating the configuration of Experimental Example 1, FIG. 6B is a diagram illustrating the configuration of Comparative Example 1, and FIG. 6C is a diagram illustrating the configuration of Comparative Example 2;

FIGS. 7A, 7B, and 7C are diagrams illustrating experimental results, FIG. 7A is a diagram illustrating the experimental results of Comparative Example 1, FIG. 7B is a diagram illustrating the experimental results of Comparative Example 2, and FIG. 7C is a diagram illustrating the experimental results of Experimental Example 1;

FIG. 8 is a diagram illustrating a charging device of Example 2 and is a diagram corresponding to FIG. 5 of Example 1;

FIG. 9 is a diagram illustrating a charging device of Example 3 and is a diagram corresponding to FIG. 5 of Example 1; and

FIG. 10 is a diagram illustrating a charging device of Example 4 and is a diagram corresponding to FIG. 5 of Example 1.

### DETAILED DESCRIPTION

Next, specific examples (hereinafter, referred to as Examples) of an exemplary embodiment of the present invention will be described with reference to the drawings. However, the present invention is not limited to the following examples.

In order to facilitate the understanding of the following description, in the drawings, a front-rear direction will be defined as an X-axis direction, a right-left direction will be defined as a Y-axis direction, and a vertical direction will be defined as a Z-axis direction. Directions or sides indicated by arrows X, −X, Y, −Y, Z, and −Z will be defined as a forward direction, a rearward direction, a rightward direction, a leftward direction, an upward direction, and a downward direction, or a front side, a rear side, a right side, a left side, an upper side, and a lower side, respectively.

Further, in the drawings, a symbol “○” with a symbol “·” therein means an arrow from the back of the plane of the sheet to the front thereof and a symbol “○” with a symbol “×” therein means an arrow from the front of the plane of the sheet to the back thereof.

In the following description using the drawings, members other than members required for description will be appropriately omitted to facilitate understanding.

### Example 1

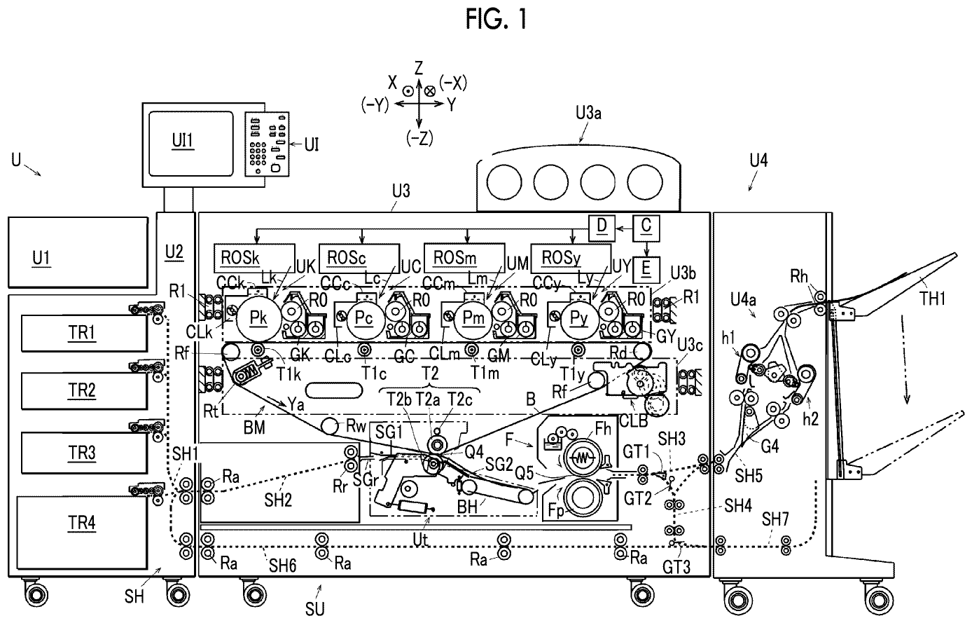

FIG. 1 is an overall view of an image forming apparatus of Example 1 of the present invention.

In FIG. 1, the image forming apparatus U includes a user interface UI as an example of an operation section, an image input device U1 as an example of an image reading section, a sheet feed device U2 as an example of a medium feed section, an image recording device U3 as an example of a body of the image forming apparatus, and a sheet processing device U4 as an example of a post-processing section.

The user interface UI includes input keys, such as a copy start key and a numeric keypad, as an example of an input section, and a display UI1.

The image input device U1 is formed of an image scanner or the like that is an example of an image reading device. In FIG. 1, the image input device U1 reads an original document (not shown) to convert the original document into image information, and inputs the image information to the image recording device U3.

The sheet feed device U2 includes sheet feed trays TR1, TR2, TR3, and TR4 as an example of a plurality of medium storage sections, a sheet feed passage SH1 through which recording sheets S as an example of mediums stored in each of the sheet feed trays TR1 to TR4 are transported, and the like.

In FIG. 1, the image recording device U3 includes an image recording unit that records an image on the recording sheet S transported from the sheet feed device U2, a toner dispenser unit U3a, a sheet transport passage SH2, a sheet discharge passage SH3, a sheet inversion passage SH4, a sheet circulation passage SH6, and the like. The image recording unit will be described later.

Further, the image recording device U3 includes a controller C as an example of a control section, a laser drive circuit D as an example of a drive circuit of a latent image writing device that is controlled by the controller C, a power source circuit E that is controlled by the controller C, and the like. The laser drive circuit D outputs laser drive signals, which correspond to image information for Y (yellow), M (magenta), C (cyan), and K (black) input from the image input device U1, to respective color latent image forming devices ROSy, ROSm, ROSc, and ROSk at preset times.

A pull-out member U3b for an image forming unit is supported below the latent image forming devices ROSy to ROSk, which are an example of a latent image forming section, by a pair of right and left guide members R1 and R1 to be movable between a pull-out position where the pull-out member U3b is pulled out to the front of the image recording device U3 and a mounting position where the pull-out member U3b is mounted inside the image recording device U3.

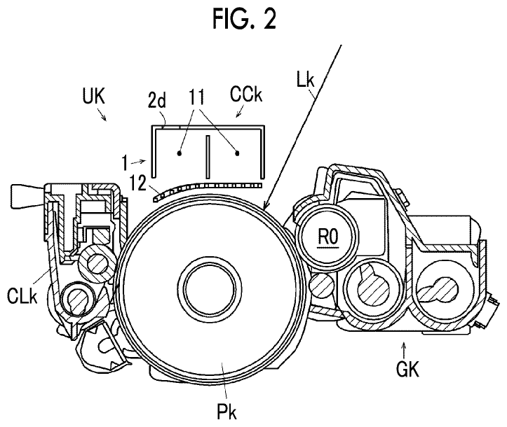

FIG. 2 is a diagram illustrating a visible image forming device that includes an image holder unit and a developing unit.

In FIGS. 1 and 2, an image holder unit UK for black includes a photoreceptor drum Pk as an example of an image holding section, a charger CCk that is an example of a charging device and an example of a charging section, and a photoreceptor cleaner CLk as an example of a cleaning section for the image holding section. In Example 1, the charger CCk is formed of a charging unit that can be attached to and detached from the image recording device U3. Further, image holder units UY, UM, and UC for the other colors Y, M, and C also include photoreceptor drums Py, Pm, and Pc, chargers CCy, CCm, and CCc, and photoreceptor cleaners CLy, CLm, and CLc. Furthermore, in Example 1, the photoreceptor drum Pk for black (K) of which the frequency of use is high and the surface is to be more worn is formed to have a larger diameter than the photoreceptor drums Py, Pm, and Pc for the other colors. Accordingly, the photoreceptor drum Pk copes with high-speed rotation and achieves a long service life.

The image holder units UY, UM, UC, and UK and developing units GY, GM, GC, and GK including developing rollers R0 constitute toner image forming members UY+GY, UM+GM, UC+GC, and UK+GK. The image holder units UY, UM, UC, and UK, and the developing units GY, GM, GC, and GK are attachably and detachably mounted on the pull-out member U3b for an image forming unit.

In FIG. 1, the photoreceptor drums Py to Pk are charged by the chargers CCy to CCk, respectively, and then electrostatic latent images are formed on the surfaces of the photoreceptor drums Py to Pk by laser beams Ly, Lm, Lc, and Lk as an example of latent image writing light output from the latent image forming devices ROSy to ROSk. The electrostatic latent images formed on the surfaces of the photoreceptor drums Py to Pk are developed into yellow (Y), magenta (M), cyan (C), and black (K) toner images by the developing units GY to GK as an example of a developing section.

The toner images on the surfaces of the photoreceptor drums Py to Pk are sequentially superimposed and transferred onto an intermediate transfer belt B, which is an example of an image holding section and an example of an intermediate transfer body, by primary transfer rollers T1y, T1m, T1c, and T1k as an example of a primary transfer section, so that a multicolor image, that is, a so-called color image is formed on the intermediate transfer belt B. The color image formed on the intermediate transfer belt B is transported to a secondary transfer region Q4.

Further, in the case of only black image data, only the photoreceptor drum Pk and the developing unit GK for black (K) are used and only a black toner image is formed.

After primary transfer, residual toner on the surfaces of the photoreceptor drums Py to Pk is cleaned off by the photoreceptor cleaners CLy to CLk.

A pull-out member U3c for an intermediate transfer body is supported below the pull-out member U3b for an image forming unit to be movable between a pull-out position where the pull-out member U3c is pulled out to the front of the image recording device U3 and a mounting position where the pull-out member U3c is mounted inside the image recording device U3. A belt module BM as an example of an intermediate transfer section is supported at the pull-out member U3c for an intermediate transfer body to be liftable and lowerable between a raised position where the belt module BM is in contact with lower surfaces of the photoreceptor drums Py to Pk and a lowered position where the belt module BM is separated downward from the lower surfaces.

The belt module BM includes the intermediate transfer belt B, a belt drive roller Rd as an example of a drive section, a tension roller Rt as an example of a tensioning section, a walking roller Rw as an example of a meandering prevention section, a plurality of idler rollers Rf as an example of a driven section, a backup roller T2a as an example of a facing section for the secondary transfer region Q4, and primary transfer rollers T1y to T1k. The intermediate transfer belt B is supported by the belt support rollers Rd, Rt, Rw, Rf, and T2a to be rotatable and movable in the direction of an arrow Ya.

A secondary transfer unit Ut is disposed below the backup roller T2a. The secondary transfer unit Ut includes a secondary transfer roller T2b as an example of a secondary transfer member. The secondary transfer roller T2b is disposed to be capable of being separated from and in contact with the backup roller T2a with the intermediate transfer belt B interposed therebetween, and a region where the secondary transfer roller T2b is in contact with the intermediate transfer belt B form the secondary transfer region Q4. Further, a contact roller T2c as an example of a voltage application section is in contact with the backup roller T2a, and the respective rolls T2a to T2c constitute a secondary transfer module T2 as an example of a secondary transfer section.

A secondary transfer voltage having a polarity identical to the charging polarity of the toner is applied to the contact roller T2c from the power source circuit E, which is controlled by the controller C, at a preset time.

The sheet transport passage SH2 is disposed below the belt module BM. The recording sheet S fed from the sheet feed passage SH1 of the sheet feed device U2 is transported to the sheet transport passage SH2, and is transported to the secondary transfer region Q4 through medium guide members SGr and SG1 before transfer by a registration roller Rr, which is an example of a section for adjusting a paper feeding time, in time with the transport of the toner images to the secondary transfer region Q4.

The toner images formed on the intermediate transfer belt B are transferred onto the recording sheet S by the secondary transfer module T2 when passing through the secondary transfer region Q4. Meanwhile, in the case of a full color image, the toner images superimposed and primarily transferred onto the surface of the intermediate transfer belt B are collectively secondarily transferred onto the recording sheet S.

The intermediate transfer belt B from which the toner images have been secondarily transferred is cleaned by a belt cleaner CLB as an example of a cleaning section for an intermediate transfer body.

The primary transfer rollers T1y to T1k, the intermediate transfer belt B, the secondary transfer module T2, the belt cleaner CLB, and the like constitute a transfer device (an example of a transfer section) T1+B+T2+CLB that transfers the images formed on the surfaces of the photoreceptor drums Py to Pk onto the recording sheet S.

The recording sheet S onto which the toner images are secondarily transferred is transported to a fixing device F through a medium guide member SG2 after transfer and a sheet transport belt BH as an example of a medium transport member before fixing. The fixing device F as an example of a fixing section includes a heating roller Fh as an example of a heating fixing section and a pressure roller Fp as an example of a pressure fixing section, and a region where the heating roller Fh and the pressure roller Fp are in contact with each other forms a fixing region Q5.

The toner images transferred onto the recording sheet S are heated and fixed by the fixing device F when passing through the fixing region Q5.

The toner image forming members UY+GY, UM+GM, UC+GC, and UK+GK and the transfer device T1+B+T2+CLB, the fixing device F, and the like constitute the image recording unit of Example 1 that records an image on the recording sheet S.

A first gate GT1 as an example of a section for switching a transport passage is provided on a downstream side of the fixing device F. The first gate GT1 selectively switches the recording sheet S, which is transported through the sheet transport passage SH2 and to which the toner images have been heated and fixed in the fixing region Q5, to either the sheet discharge passage SH3 or the sheet inversion passage SH4 of the image recording device U3. The recording sheet S transported to the sheet discharge passage SH3 is transported to a sheet transport passage SH5 of the sheet processing device U4.

A curl correction device U4a as an example of a curvature correction section is disposed in the middle of the sheet transport passage SH5, and a second gate G4 as an example of a section for switching a transport passage is disposed in the sheet transport passage SH5. The second gate G4 transports the recording sheet S, which is transported from the sheet discharge passage SH3 of the image recording device U3, toward either a first curl correction member h1 or a second curl correction member h2 depending on a direction of curvature, that is, so-called curl. The curl of the recording sheet S transported to the first curl correction member h1 or the second curl correction member h2 is corrected while the recording sheet S passes through the first curl correction member h1 or the second curl correction member h2. The recording sheet S of which the curl is corrected is discharged from a discharge roller Rh as an example of a discharge section to a discharge tray TH1 as an example of a discharge unit of the sheet processing device U4 in a state where a surface of the sheet to which the images are fixed faces upward, that is, in a so-called face-up state.

The recording sheet S, which is transported toward the sheet inversion passage SH4 of the image recording device U3 by the first gate GT1, passes through a transport direction-restricting section formed of an elastic thin film-like member, that is, a so-called miller gate GT2 while pushing the miller gate GT2, and is transported to the sheet inversion passage SH4 of the image recording device U3.

The sheet circulation passage SH6 and a sheet inversion passage SH7 are connected to a downstream end of the sheet inversion passage SH4 of the image recording device U3, and a miller gate GT3 is also disposed at a connection portion where the sheet circulation passage SH6 and the sheet inversion passage SH7 are connected to the sheet inversion passage SH4. The sheet, which is transported to the sheet inversion passage SH4 through the first gate GT1, passes through the miller gate GT3 and is transported toward the sheet inversion passage SH7 of the sheet processing device U4. In a case where two-sided printing is performed, the recording sheet S that has been transported through the sheet inversion passage SH4 passes through the miller gate GT3 and is transported to the sheet inversion passage SH7 and is then transported in a reverse direction, that is, so-called switched back. In this case, the recording sheet S of which the transport direction is restricted by the miller gate GT3 and which has been switched back is transported toward the sheet circulation passage SH6. The recording sheet S transported to the sheet circulation passage SH6 is transported to the secondary transfer region Q4 through the sheet feed passage SH1 again.

On the other hand, in a case where the recording sheet S transported through the sheet inversion passage SH4 is switched back before a rear end of the recording sheet S passes through the miller gate GT3 after passing through the miller gate GT2, the transport direction of the recording sheet S is restricted by the miller gate GT2 and the recording sheet S is transported to the sheet transport passage SH5 in a state where the recording sheet S is inverted. After the curl of the inverted recording sheet S is corrected by the curl correction device U4a, the inverted recording sheet S can be discharged to the discharge tray TH1 of the sheet processing device U4 in a state where the surface of the recording sheet S to which the images are fixed faces downward, that is, in a so-called face-down state.

The elements denoted by the reference numerals SH1 to SH7 constitute a sheet transport passage SH. Further, the elements denoted by the reference numerals SH, Ra, Rr, Rh, SGr, SG1, SG2, BH, and GT1 to GT3 constitute a sheet transport device SU.

### Description of Charger

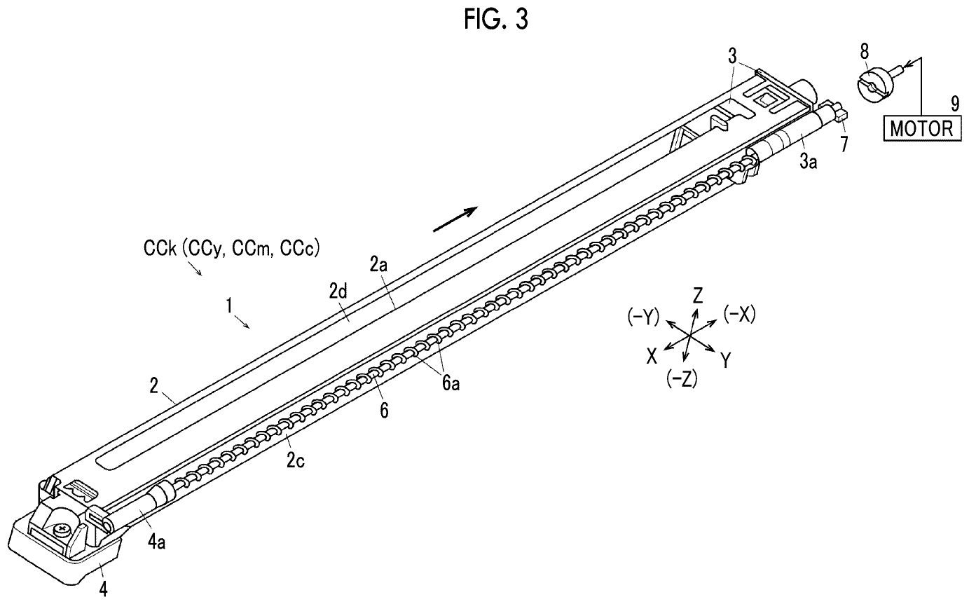

FIG. 3 is a perspective view of the charger of Example 1 of the present invention.

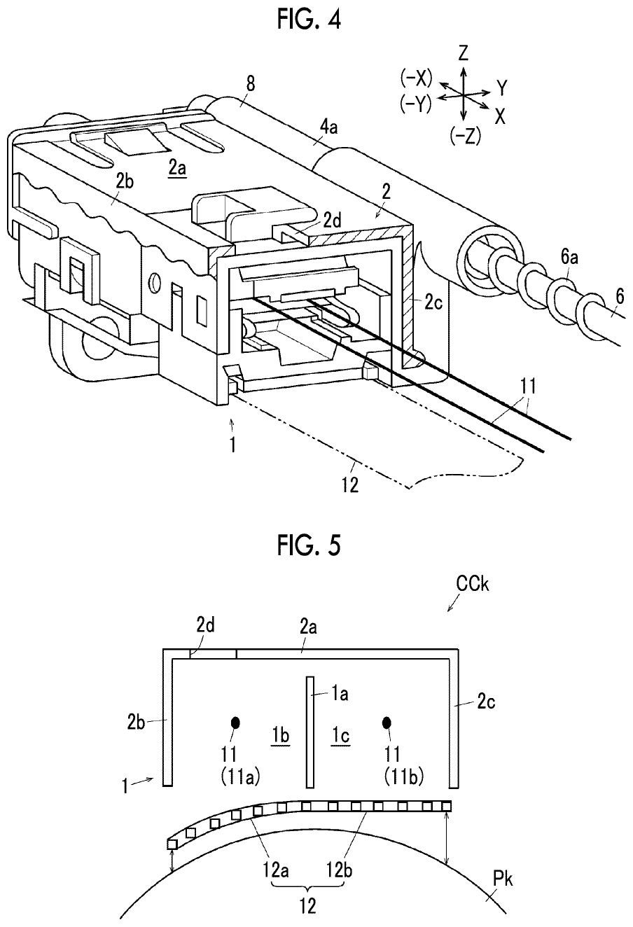

FIG. 4 is a cross-sectional view of a major part of the charger of Example 1 of the present invention.

In FIG. 4, a part of a shield electrode is not shown to facilitate the understanding of the invention.

Next, the charger of Example 1 will be described. However, since the chargers CCy to CCk for the respective colors of Y, M, C, and K have an identical configuration, the charger CCk for black (K) will be described in detail and the detailed description of the chargers CCy to CCc of the other colors will be omitted.

In FIGS. 2, 3, and 4, the charger CCk of Example 1 includes a charger body 1 that extends in the front-rear direction. The charger body 1 includes a shield electrode 2 as an example of a housing. The shield electrode 2 is made of a conductive metal material. The shield electrode 2 includes a plate-like upper wall portion 2a that extends in the front-rear direction, and plate-like left and right wall portions 2b and 2c that extend downward from both left and right sides of the upper wall portion 2a. An opening 2d extending in the front-rear direction is formed at a left portion of the upper wall portion 2a.

A rear end block 3 as an example of one end member is supported at a rear end of the shield electrode 2, and a front end block 4 as an example of the other end member is supported at a front end of the shield electrode 2. Tubular shaft receiving portions 3a and 4a extending in the front-rear direction are formed at upper right portions of the front and rear blocks 3 and 4 as an example of a support body for a movable cleaning member.

A shaft 6, which extends in the front-rear direction, as an example of a rotating member is rotatably supported by the shaft receiving portions 3a and 4a. A thread 6a is formed on an outer peripheral surface of the shaft 6. A rear end portion of the shaft 6 penetrates the rear shaft receiving portion 4a and extends rearward, and a driven coupling 7 as an example of a transmission target member is supported at the rear end of the shaft 6. A drive coupling 8 as an example of a transmission member is disposed in the image recording device U3. In a case where the charger CCk is mounted on the image recording device U3, the driven coupling 7 is supported in a state where the driven coupling 7 meshes with the drive coupling 8. The drive coupling 8 is adapted such that drive from a motor 9 for an electrode cleaner as an example of a drive source for an electrode cleaning member can be transmitted to the drive coupling 8. A motor that can be driven in a normal direction and a reverse direction is used as the motor 9 for an electrode cleaner of Example 1.

An aspect in which the shaft 6 is disposed on the right side of the charger CCk has been exemplified in Example 1, but the present invention is not limited thereto. The shaft 6 may be disposed on the upper portion or the left side of the charger CCk.

FIG. 5 is an enlarged view of a major part of the charging device of Example 1.

In FIGS. 2 to 5, a wire electrode 11, which is an example of a discharge electrode and an example of a first electrode, is disposed in the charger body 1. The wire electrode 11 of Example 1 is formed of wire rods extending in the front-rear direction. The charger CCk of Example 1 includes a first wire electrode 11a that is disposed on an upstream side in a rotation direction of the photoreceptor drum Pk and a second wire electrode 11b that is disposed on a downstream side thereof.

A partition wall 1a as an example of a partition section is disposed in the charger body 1 between the first wire electrode 11a as an example of a first discharge electrode and the second wire electrode 11b as an example of a second discharge electrode. Therefore, the inside of the charger body 1 is partitioned into a first charging chamber 1b that is formed between a left wall portion 2b as an example of an upstream surrounding portion and the partition wall 1a and a second charging chamber 1c that is formed between a right wall portion 2c as an example of a downstream surrounding portion and the partition wall 1a.

Both front and rear ends of the wire electrode 11 are supported by the respective blocks 3 and 4. A grid electrode 12, which is an example of a control electrode and an example of a second electrode, is supported at a position of a lower opening of the shield electrode 2 between the wire electrode 11 and the photoreceptor drum Pk, that is, in a charging region that is a region facing the photoreceptor drum Pk as an example of a member to be charged.

In a case where a voltage is applied to the grid electrode 12 to control electric charges in a state where power is supplied to the wire electrode 11, discharge occurs due to a potential difference between the wire electrode 11 and the grid electrode 12. The surface of the photoreceptor drum Pk is charged by discharged electric charges.

The grid electrode 12 of Example 1 includes an upstream portion 12a that is disposed at an opening portion of the first charging chamber 1b and a downstream portion 12b that is disposed at an opening portion of the second charging chamber 1c. The grid electrode 12 of Example 1 is adapted such that an interval between the grid electrode 12 and the photoreceptor drum Pk at the downstream portion 12b in the rotation direction of the photoreceptor drum Pk is larger than that at the upstream portion 12a. Specifically, the upstream portion 12a of Example 1 is formed in a curved shape along the surface shape of the photoreceptor drum Pk. The downstream portion 12b is formed in the shape of a flat plate extending in a tangential direction from a curved end portion (downstream end portion) of the upstream portion 12a. Therefore, a distance between the upstream portion 12a and the photoreceptor drum Pk is kept constant, and a distance between the downstream portion 12b and the photoreceptor drum Pk is increased toward the downstream side.

### Action of Example 1

In the charger CCk of Example 1 having the above-described configuration, electric charges are released from the wire electrode 11 due to a potential difference between the wire electrode 11 and the grid electrode 12. The released electric charges are moved to the photoreceptor drum Pk, so that the photoreceptor drum Pk is charged.

Since the grid electrode 12 of the charger CCk is curved along the photoreceptor drum Pk, a distance between the photoreceptor drum Pk and the grid electrode 12 is made uniform from the upstream to the downstream in the rotation direction of the photoreceptor drum Pk. Accordingly, charging efficiency can be improved as compared to a case where the grid electrode 12 is not curved. Therefore, it is possible to cope with an increase in the rotational speed of the photoreceptor drum Pk. Here, in a case where an abutting portion or the like allowing the grid electrode 12 to be curved is provided in a middle portion of the grid electrode 12 in a longitudinal direction, charging is insufficient in the middle portion of the photoreceptor drum Pk in an axial direction. For this reason, a force for curving the grid electrode 12 needs to be applied to both end portions of the grid electrode 12 in the longitudinal direction. However, in a case where the grid electrode 12 is to be curved at both end portions of the grid electrode 12, the grid electrode 12 is likely to return to a flat state in the middle portion thereof in the longitudinal direction and the curved state is not maintained over the entire grid electrode 12 in the longitudinal direction. In a case where the grid electrode 12 returns to the flat state, the middle portion of the grid electrode 12 in the longitudinal direction is likely to sag due to one's own weight since tension for maintaining the posture of the grid electrode 12 is insufficient. Therefore, a variation in charging capability may occur in the longitudinal direction of the charger CCk and cause a variation in the charged state of the photoreceptor drum Pk.

Here, in the technique disclosed in JP2012-220724A (Paragraph 0026 to 0037 and FIGS. 3 and 5), an interval between the grid electrode (23) and the photoreceptor drum (13) is wide on the upstream side and is narrow on the downstream side. Since the entire grid electrode (23) from the upstream side to the downstream side (in the lateral direction) has a curved shape, a variation in the charging capability may occur at end portions and the middle portion of the grid electrode (23) in the longitudinal direction.

On the other hand, in Example 1, the upstream portion 12a is curved and the downstream portion 12b is formed in the shape of a flat plate. Therefore, it is possible to cope with an increase in speed as compared to a configuration in the related art in which the entire grid electrode has the shape of a flat plate. Further, a variation in the charged state in the longitudinal direction is suppressed as compared to a configuration of the related art in which the entire grid electrode has a curved shape.

### Experimental Examples

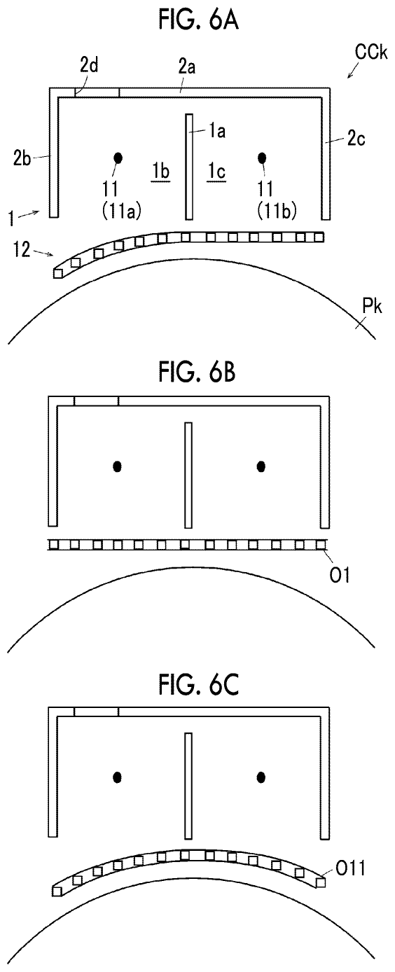

FIGS. 6A, 6B, and 6C are diagrams illustrating configurations of Experimental Examples, FIG. 6A is a diagram illustrating the configuration of Experimental Example 1, FIG. 6B is a diagram illustrating the configuration of Comparative Example 1, and FIG. 6C is a diagram illustrating the configuration of Comparative Example 2.

Experiments are performed on how the charging potential of the photoreceptor drum Pk in the rotation direction changes.

The experiments are performed in a case where the upstream portion 12a is curved and the downstream portion 12b has the shape of a flat plate as shown in FIG. 6A (Experimental Example 1), in a case where the entire grid electrode 01 has the shape of a flat plate as shown in FIG. 6B (Comparative Example 1), and in a case where the entire grid electrode 011 has a curved shape as shown in FIG. 6C (Comparative Example 2).

Experiments are performed on the transition of the charging potential of the surface of the photoreceptor drum Pk in the middle portion in the longitudinal direction and at the end portions in the longitudinal direction. In the experiments, the rotational speed of the photoreceptor drum Pk is 635 mm/s. The diameter of the photoreceptor drum is 84 mm. The lengths of the grid electrodes 12, 01, and 011 in the longitudinal direction are 336 mm. In Comparative Example 1, the shortest distance between the grid electrode 01 and the photoreceptor drum is 1.1 mm and the longest distance therebetween is 3.6 mm. In Comparative Example 2, a distance between the grid electrode 011 and the photoreceptor drum is 1.1 mm.

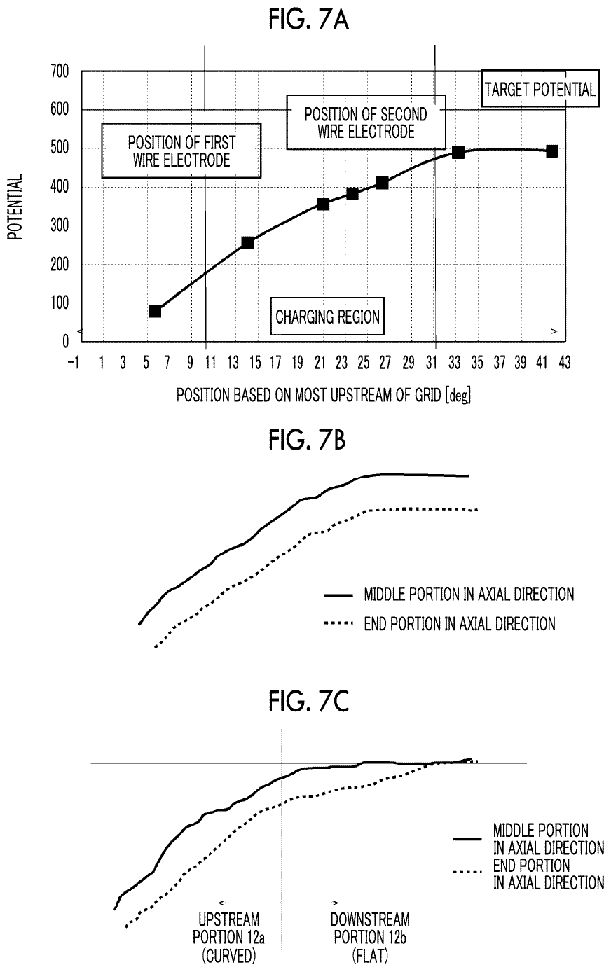

Results are shown in FIGS. 7A, 7B, and 7C.

FIGS. 7A, 7B, and 7C are diagrams illustrating experimental results, FIG. 7A is a diagram illustrating the experimental results of Comparative Example 1, FIG. 7B is a diagram illustrating the experimental results of Comparative Example 2, and FIG. 7C is a diagram illustrating the experimental results of Experimental Example 1.

In FIG. 7A, in Comparative Example 1, in a case where the rotational speed of the photoreceptor drum is high, a charging potential does not reach a target potential and a charging failure occurs. In Comparative Example 1, the grid electrode 01 has the shape of a flat plate and a variation in charging potentials at the end portions and the middle portion of the photoreceptor drum in the axial direction is small.

In FIG. 7B, in Comparative Example 2, the charging potential of the middle portion of the photoreceptor drum in the longitudinal direction is excessive in settings where a charging potential reaches a target charging potential at end portions of the photoreceptor drum in the longitudinal direction at a downstream end of the charging region.

In FIG. 7C, the charging potential of the photoreceptor drum is rapidly increased toward the downstream side at the upstream portion 12a, and an increase in the charging potential of the photoreceptor drum is gentle at the downstream portion 12b. In particular, at the downstream portion 12b, the charging potential of the middle portion of the photoreceptor drum in the longitudinal direction is not excessive and the charging potential of the end portions of the photoreceptor drum also reaches the target charging potential.

In the charger CCk of Example 1, the upstream portion 12a has a curved shape, has high charging capability, and can cope with an increase in speed. Further, the downstream portion 12b has the shape of a flat plate, and has identical charging capability at the middle portion and the end portions thereof in the longitudinal direction, and has charging capability lower than the charging capability of the upstream portion 12a. Accordingly, the charging potential of the middle portion of the photoreceptor drum in the longitudinal direction is less likely to be excessive. The end portions of the photoreceptor drum in the longitudinal direction are charged to a charging potential higher than that in Comparative Example 1 at the upstream portion 12a, and can be charged to the target potential even with the charging capability of the downstream portion 12b. Therefore, in the charger CCk of Example 1, the photoreceptor drum can be charged to the target potential, and the occurrence of a charging failure and insufficient charging is suppressed as compared to a case where the grid electrode 12 has the shape of a flat plate (Comparative Example 1). Further, in the charger CCk of Example 1, charging unevenness in the longitudinal direction of the grid electrode 12 is suppressed as compared to a case where the grid electrode 12 is curved in the lateral direction to correspond to the curvature of the photoreceptor drum Pk (Comparative Example 2).

### Example 2

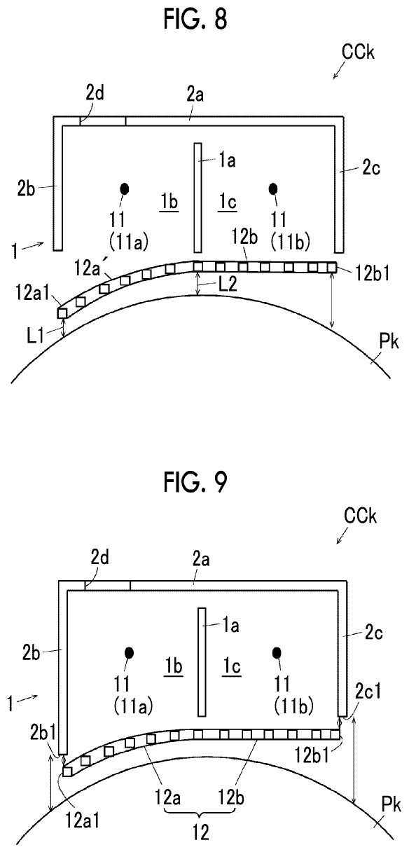

FIG. 8 is a diagram illustrating a charging device of Example 2 and is a diagram corresponding to FIG. 5 of Example 1.

In the description of Example 2, components corresponding to the components of Example 1 will be denoted by identical reference numerals and detailed description thereof will be omitted.

Example 2 is different from Example 1 in terms of the following points, but has a configuration identical to the configuration of Example 1 in terms of other points.

In FIG. 8, in a charger CCk of Example 2, a grid electrode 12 is adapted such that an interval between the grid electrode 12 and the photoreceptor drum Pk is increased from an upstream end 12a1 of an upstream portion 12a′ toward a downstream end 12b1 of a downstream portion 12b. Specifically, the upstream portion 12a′ is formed such that the interval is smallest at the upstream end 12a1 and a radius of curvature of the upstream portion 12a′ is larger than a radius of curvature of the surface of the photoreceptor drum Pk. Further, the downstream portion 12b is formed in the shape of a flat plate as in Example 1.

Therefore, even in the charger CCk of Example 2, charging capability is higher on the upstream side and the occurrence of insufficient charging is suppressed even in the case of high speed. Further, a variation in charging capability is suppressed on the downstream side, so that charging unevenness is suppressed.

### Example 3

FIG. 9 is a diagram illustrating a charging device of Example 3 and is a diagram corresponding to FIG. 5 of Example 1.

In the description of Example 3, components corresponding to the components of Example 1 will be denoted by identical reference numerals and detailed description thereof will be omitted.

Example 3 is different from Example 1 in terms of the following points, but has a configuration identical to the configuration of Example 1 in terms of other points.

In FIG. 9, in a charger CCk of Example 3, an interval between an upstream end portion 2b1 of a shield electrode 2 and the surface of the photoreceptor drum Pk is set to be smaller than an interval between a downstream end portion 2c1 of the shield electrode 2 and the surface of the photoreceptor drum Pk in the rotation direction of the photoreceptor drum Pk. Accordingly, an interval between the upstream end portion 2b1 and a grid electrode 12 is small as compared to the configuration of Example 1. Therefore, the leakage of discharge products, such as ozone, from a gap between the upstream end portion 2b1 and the grid electrode 12 is suppressed as compared to Example 1.

### Example 4

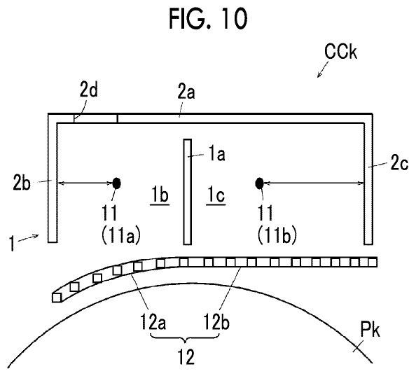

FIG. 10 is a diagram illustrating a charging device of Example 4 and is a diagram corresponding to FIG. 5 of Example 1.

In the description of Example 4, components corresponding to the components of Example 1 will be denoted by identical reference numerals and detailed description thereof will be omitted.

Example 4 is different from Example 1 in terms of the following points, but has a configuration identical to the configuration of Example 1 in terms of other points.

In FIG. 10, in a charger CCk of Example 4, a distance between a right wall portion 2c of a shield electrode 2 and a wire electrode 11 is set to be larger than a distance between a left wall portion 2b of the shield electrode 2 and the wire electrode 11 in the rotation direction of the photoreceptor drum Pk. Specifically, a distance between the right wall portion 2c and the second wire electrode 11b is set to be larger than a distance between the left wall portion 2b and the first wire electrode 11a.

Among electric charges released from the wire electrode 11, electric charges not having reached the photoreceptor drum Pk are absorbed by the shield electrode 2. Therefore, in a case where a distance between the shield electrode 2 and the wire electrode 11 is increased, the number of electric charges absorbed by the shield electrode 2 is reduced and more electric charges are supplied to the photoreceptor drum Pk by that much. In Examples 1 and 4, the charging capability of the downstream portion 12b is lower than the charging capability of the upstream portion 12a. However, in a case where the charging capability of the downstream portion 12b is insufficient, the distance between the shield electrode 2 and the wire electrode 11 can also be increased as in Example 4 to compensate for the lack of charging capability.

### Modification Examples

Examples of the present invention have been described in detail above. However, the present invention is not limited to Examples described above, and can have various modifications without departing from the scope of the present invention described in claims. Modification Examples (H01) to (H06) of the present invention will be exemplified below.

(H01) In Examples described above, the present invention is not limited to the copying machine as an example of the image forming apparatus and can also be applied to image forming apparatuses, such as a printer and a FAX. Further, the present invention is not limited to the color image forming apparatus and can also be applied to a monochrome image forming apparatus. Furthermore, the present invention is not limited to the tandem type image forming apparatus, and can also be applied to a rotary type image forming apparatus.

(H02) A case where the wire electrode 11 is two wire rods has been exemplified in Examples described above. However, the present invention is not limited thereto, and a configuration in which the wire electrode 11 includes one or three or more wire rods or the like can also be adopted.

(H03) A configuration in which the shield electrode 2 is not provided can also be adopted in Examples described above.

(H04) The scorotron type charger has been exemplified in Examples described above, but the present invention is not limited thereto. For example, other discharge type chargers can also be used as a static eliminator or an auxiliary charger for the photoreceptor drums Py to Pk or the recording sheet S, the transfer modules T1y to T1k and T2, and the like.

(H05) The net-like grid electrode 12 has been exemplified as an example of the control electrode in Examples described above, but the present invention is not limited thereto. For example, the present invention can also be applied to a control electrode in a form (vertical stripe shape) in which a plurality of wires extend in a longitudinal direction.

(H06) In Examples described above, a distance between the grid electrode 12 and the photoreceptor drum Pk can be increased monotonically from the upstream side of the grid electrode 12 to the downstream side thereof.

### Supplementary Note

(((1)))

A charging device comprising:
a discharge electrode; and
a control electrode that is disposed between the discharge electrode and a member to be charged,
wherein an interval between the control electrode and the member to be charged at a downstream portion of the control electrode in a rotation direction of the member to be charged is larger than an interval between the control electrode and the member to be charged at an upstream portion of the control electrode.
(((2)))

The charging device according to (((1))),
wherein the upstream portion having a curved shape along a surface shape of the member to be charged and the downstream portion having a shape of a flat plate extending in a tangential direction from a curved end portion of the upstream portion are provided.
(((3)))

The charging device according to (((1))),
wherein an interval between the control electrode and the member to be charged is increased from an upstream end of the upstream portion toward a downstream end of the downstream portion.
(((4)))

The charging device according to any one of (((1))) to (((3))), further comprising:
a housing that is disposed to surround the discharge electrode,
wherein an interval between an upstream end portion of the housing and a surface of the member to be charged is smaller than an interval between a downstream end portion of the housing and the surface of the member to be charged in the rotation direction of the member to be charged.
(((5)))

The charging device according to any one of (((1))) to (((4))), further comprising:
a housing that is disposed to surround the discharge electrode,
wherein a distance between a downstream surrounding portion of the housing on a downstream side in the rotation direction of the member to be charged and the discharge electrode is larger than a distance between an upstream surrounding portion of the housing on an upstream side in the rotation direction of the member to be charged and the discharge electrode.
(((6)))

The charging device according to (((5))),
wherein the discharge electrode includes a first discharge electrode that is disposed to correspond to an upstream portion of the control electrode and a second discharge electrode that is disposed to correspond to a downstream portion of the control electrode, and
a distance between the downstream surrounding portion and the second discharge electrode is larger than a distance between the upstream surrounding portion and the first discharge electrode.
(((7)))

An image forming apparatus comprising:
a member to be charged that is formed of an image holding section;
a charging device according to any one of (((1))) to (((6))) that charges the image holding section;
a latent image forming section that forms a latent image on the image holding section;
a developing section that develops the latent image formed on the image holding section;
a transfer section that transfers an image developed by the developing section onto a medium, and
a fixing device that fixes the image to the medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A charging device comprising:
a discharge electrode; and
a control electrode that is disposed between the discharge electrode and a member to be charged,
wherein an interval between the control electrode and the member to be charged at a downstream portion of the control electrode in a rotation direction of the member to be charged is larger than an interval between the control electrode and the member to be charged at an upstream portion of the control electrode.

2. The charging device according to claim 1,
wherein the upstream portion having a curved shape along a surface shape of the member to be charged and the downstream portion having a shape of a flat plate extending in a tangential direction from a curved end portion of the upstream portion are provided.

3. The charging device according to claim 1,
wherein an interval between the control electrode and the member to be charged is increased from an upstream end of the upstream portion toward a downstream end of the downstream portion.

4. The charging device according to claim 1, further comprising:
a housing that is disposed to surround the discharge electrode,
wherein an interval between an upstream end portion of the housing and a surface of the member to be charged is smaller than an interval between a downstream end portion of the housing and the surface of the member to be charged in the rotation direction of the member to be charged.

5. The charging device according to claim 1, further comprising:
a housing that is disposed to surround the discharge electrode,
wherein a distance between a downstream surrounding portion of the housing on a downstream side in the rotation direction of the member to be charged and the discharge electrode is larger than a distance between an upstream surrounding portion of the housing on an upstream side in the rotation direction of the member to be charged and the discharge electrode.

6. The charging device according to claim 5,
wherein the discharge electrode includes a first discharge electrode that is disposed to correspond to an upstream portion of the control electrode and a second discharge electrode that is disposed to correspond to a downstream portion of the control electrode, and
a distance between the downstream surrounding portion and the second discharge electrode is larger than a distance between the upstream surrounding portion and the first discharge electrode.

7. An image forming apparatus comprising:
a member to be charged that is formed of an image holding section;
a charging device according to claim 1 that charges the image holding section;
a latent image forming section that forms a latent image on the image holding section;
a developing section that develops the latent image formed on the image holding section;
a transfer section that transfers an image developed by the developing section onto a medium, and
a fixing device that fixes the image to the medium.

8. An image forming apparatus comprising:
a member to be charged that is formed of an image holding section;
a charging device according to claim 2 that charges the image holding section;
a latent image forming section that forms a latent image on the image holding section;
a developing section that develops the latent image formed on the image holding section;
a transfer section that transfers an image developed by the developing section onto a medium, and
a fixing device that fixes the image to the medium.

9. An image forming apparatus comprising:
a member to be charged that is formed of an image holding section;
a charging device according to claim 3 that charges the image holding section;
a latent image forming section that forms a latent image on the image holding section;
a developing section that develops the latent image formed on the image holding section;
a transfer section that transfers an image developed by the developing section onto a medium, and
a fixing device that fixes the image to the medium.

10. An image forming apparatus comprising:
a member to be charged that is formed of an image holding section;
a charging device according to claim 4 that charges the image holding section;
a latent image forming section that forms a latent image on the image holding section;
a developing section that develops the latent image formed on the image holding section;
a transfer section that transfers an image developed by the developing section onto a medium, and
a fixing device that fixes the image to the medium.

11. An image forming apparatus comprising:
a member to be charged that is formed of an image holding section;
a charging device according to claim 5 that charges the image holding section;
a latent image forming section that forms a latent image on the image holding section;
a developing section that develops the latent image formed on the image holding section;
a transfer section that transfers an image developed by the developing section onto a medium, and
a fixing device that fixes the image to the medium.

12. An image forming apparatus comprising:
a member to be charged that is formed of an image holding section;
a charging device according to claim 6 that charges the image holding section;
a latent image forming section that forms a latent image on the image holding section;
a developing section that develops the latent image formed on the image holding section;
a transfer section that transfers an image developed by the developing section onto a medium, and
a fixing device that fixes the image to the medium.
